(19) United States
(12) Patent Application Publication
(10) Pub. No.: US 2023/0408038 A1
(43) Pub. Date: Dec. 21, 2023

(54) COUPLING DEVICE AND CRYOGENIC REFUELING ARRANGEMENT

(71) Applicants: LINDE GMBH, Pullach (DE); Butting CryoTech GmbH, Burgkirchen (DE)

(72) Inventors: Florian EHEGARTNER, Pullach (DE); Bernhard REITER, Grabenstätt (DE)

(21) Appl. No.: 18/247,701

(22) PCT Filed: Oct. 1, 2021
(86) PCT No.: PCT/EP2021/025378

§ 371 Date: Apr. 3, 2023

(30) Foreign Application Priority Data
Oct. 2, 2020 (EP) 20020451.9

(51) Int. Cl. F17C 13/04

(52) U.S. Cl. CPC F17C 13/04; F17C 2205/037; F17C 2205/0326; F17C 2223/0161; F17C 2265/065; F17C 2205/0335; F17C 2221/012

(57) ABSTRACT

A coupling device for a cryogenic refueling arrangement, having a main valve; a venting valve which is connected parallel to the main valve and which serves for venting a volume, which is provided downstream of the main valve and the venting valve, in order to prepare the coupling device for a refueling operation; a housing which encloses a further volume in which the main valve and the venting valve are arranged; and a shut-off valve which is provided on the housing and by means of which the volume enclosed by the housing is accessible.

The invention relates to a coupling device for a cryogenic refueling arrangement and a cryogenic refueling arrangement having such a coupling device.

In a cryogenic refueling arrangement, a dead volume is created in the coupling device when a coupling device is coupled, for example, to a vehicle. This must be cleared and flushed of atmospheric air or undesirable media, for example via a refueling hose or a refueling pipe system of the coupling device. According to company-internal findings of the applicant, with some cryogenic refueling arrangements the problem can arise that the flushing of the entire refueling hose or the refueling pipe system has to be configured in terms of process engineering in such a way that cold running of the refueling hose or the refueling pipe system before coupling may not be possible if the dead volume would have to be discharged through the cryogenic filling hose or the refueling pipe system. Since the dead volume can contain humidity, for example, it can lead to ice formation within the refueling hose or the refueling pipe system and on valve components. This must be prevented.

Against this background, one object of the present invention is to provide an improved coupling device.

Accordingly, a coupling device for a cryogenic refueling arrangement is proposed. The coupling device comprises a main valve, a venting valve for venting a volume provided downstream of the main valve and the venting valve, in order to thereby prepare the coupling device for a refueling operation, a housing which encloses a further volume in which the main valve and the venting valve are arranged, and a shut-off valve provided on the housing, by means of which the volume enclosed by the housing is accessible.

In a further development, a coupling device for a cryogenic refueling arrangement is proposed. The coupling device comprises a main valve and a venting valve connected parallel to the main valve, wherein the venting valve is configured to vent a volume provided downstream of the main valve and the venting valve in order to thereby prepare the coupling device for a refueling operation.

Due to the venting valve being provided, a dead volume is minimized. By designing the main valve and the venting valve as actuatable valves, a refueling operation, for example with a cryogen, can be carried out automatically.

Since the shut-off valve by means of which the volume enclosed by the housing is accessible is provided on the housing, it is possible to achieve the technical effect that components or parts provided or arranged within the volume, such as a coupling arranged downstream of the main valve and the venting valve, are shielded from the surroundings of the coupling device. As a result, a freezing of water vapor or gases on these parts can be reliably prevented, for example. It is thus possible to always keep these parts dry.

Preferably, the main valve and the venting valve are arranged next to one another and connected parallel to one another by means of suitable pipework or by means of suitable lines. A “parallel connection” is preferably understood to mean an arrangement in which the main valve and the venting valve are arranged next to or adjacent to one another, so that a fluid, for example the cryogen, can flow through either the main valve or the venting valve or both the main valve and the venting valve. In contrast to this, a series connection can be considered in which the fluid must always flow through both the main valve and the venting valve in succession.

The main valve and the venting valve can each be designed as open/close valves. The fact that the volume is provided “downstream” of the main valve and the venting valve means in the present case in particular that the volume is arranged downstream of the main valve and the venting valve in a flow direction of a cryogen flowing through the coupling device. The coupling device is particularly suitable for refueling a storage tank with the cryogen, for example. The cryogen can be, for example, liquid hydrogen, monosilane, ethylene or the like.

The shut-off valve is preferably a ball valve or can be referred to as a ball valve. The shut-off valve can be moved from a closed state to an open state and vice versa. In the open state, the volume enclosed by the housing is accessible via the shut-off valve. In the present case, “accessible” means in particular that components or parts can be inserted through the shut-off valve into the volume or components or parts can be pushed out or guided out of the volume through the shut-off valve. The main valve and the venting valve are arranged in particular within the housing, which surrounds the volume.

According to one embodiment, the venting valve is pneumatically actuated.

This enables automated actuation of the venting valve. However, the venting valve can be actuated in any way. The main valve can also be actuated pneumatically.

According to a further embodiment, the coupling device further comprises a coupling leading away from the main valve and a line which leads from the venting valve toward the coupling and is in fluid communication with the coupling, wherein the volume is enclosed by the coupling and the line.

According to a further embodiment, the coupling device further comprises a coupling leading away from the main valve, wherein the coupling is arranged within the volume that is enclosed by the housing, and wherein the coupling is accessible by means of the shut-off valve.

According to a further embodiment, the coupling device further comprises a line which leads from the venting valve toward the coupling and is in fluid communication with the coupling, wherein the volume provided downstream of the main valve and the venting valve is enclosed by the coupling and the line.

This means that the volume in the coupling and the line is provided. Preferably, a line leads in each case from a coupling provided on a housing of the coupling device to the main valve and to the venting valve. Since the coupling is arranged within the volume enclosed by the housing, it is possible, as mentioned above, to shield the coupling from the surroundings of the coupling device. A freezing of water vapor or gases at the coupling is reliably prevented as a result. The coupling can thus always be kept dry. The shut-off valve thus protects the cold coupling or shields it.

According to a further embodiment, the coupling device further comprises a housing with a first wall and a second wall accommodated within the first wall, wherein the main valve and the venting valve are arranged inside the second wall.

According to a further embodiment, the housing has a first wall and a second wall accommodated within the first wall, wherein the main valve and the venting valve are arranged inside the second wall.

This means in particular that the housing is double-walled.

According to a further embodiment, the second wall surrounds the volume enclosed by the housing.

This means in particular that the second wall limits or defines the volume enclosed by the housing. The main valve, the venting valve and the coupling are placed within this aforementioned volume.

According to a further embodiment, the main valve and the venting valve are arranged parallel to one another.

In particular, the main valve and the venting valve are placed next to one another or adjacent to one another. This can be achieved structurally, for example, in such a way that the venting valve is accommodated within a valve piston or valve body of the main valve and is in particular mounted movably therein or thereon. The main valve and the venting valve can be actuated independently of one another.

According to a further embodiment, the coupling device further comprises a shut-off valve provided on the housing, by means of which a volume enclosed by the second wall is accessible.

This shut-off valve is in particular an open/close valve. A receiver connector which fits into the coupling device can also comprise such a shut-off valve.

Furthermore, a cryogenic refueling arrangement with such a coupling device and a receiver connector to which the coupling device can be coupled is proposed.

The coupling device can be inserted into the receiver connector or vice versa. The refueling operation can then be carried out automatically.

According to one embodiment, the receiver connector comprises a first engagement element, wherein the coupling device comprises a first counter-engagement element corresponding to the first engagement element, and wherein the first engagement element engages in an interlocking manner in the first counter-engagement element in a first position of the coupling device.

The first engagement element can be a displaceable pin, for example. The first counter-engagement element can be a recess or bore corresponding thereto. An interlocking connection is produced by the engagement of at least two connection partners in or behind one another, in the present case the first engagement element and the first counter-engagement element.

According to a further embodiment, the coupling device comprises a second engagement element, wherein the receiver connector comprises a second counter-engagement element corresponding to the second engagement element, and wherein the second engagement element engages in an interlocking manner in the second counter-engagement element in a second position of the coupling device that differs from the first position.

The second engagement element can be a displaceable pin, for example. The second counter-engagement element can be a recess or bore corresponding thereto.

According to a further embodiment, the coupling device and the receiver connector are pushed further into one another in the second position than they are in the first position.

According to a further embodiment, a refueling operation can only be started in the second position.

In the present case, “a(n)” is not necessarily to be understood as limiting to exactly one element. It is rather the case that several elements, such as two, three, or more, may also be provided. Any other numerical word used herein is also not to be understood as meaning an exact limitation to exactly the corresponding number of elements. Rather, numerical differences upward or downward are possible.

Further possible implementations of the coupling device and/or of the cryogenic refueling arrangement also include combinations of features or embodiments described above or below with respect to the exemplary embodiments that are not explicitly mentioned. A person skilled in the art will also add individual aspects as improvements or additions to the particular basic form of the coupling device and/or of the cryogenic refueling arrangement.

Further advantageous embodiments of the coupling device and/or of the cryogenic refueling arrangement are the subject matter of the dependent claims and of the exemplary embodiments of the coupling device and/or of the cryogenic refueling arrangement described below. Furthermore, the coupling device and/or the cryogenic refueling arrangement are explained below in more detail in reference to the accompanying figures based on preferred embodiments.

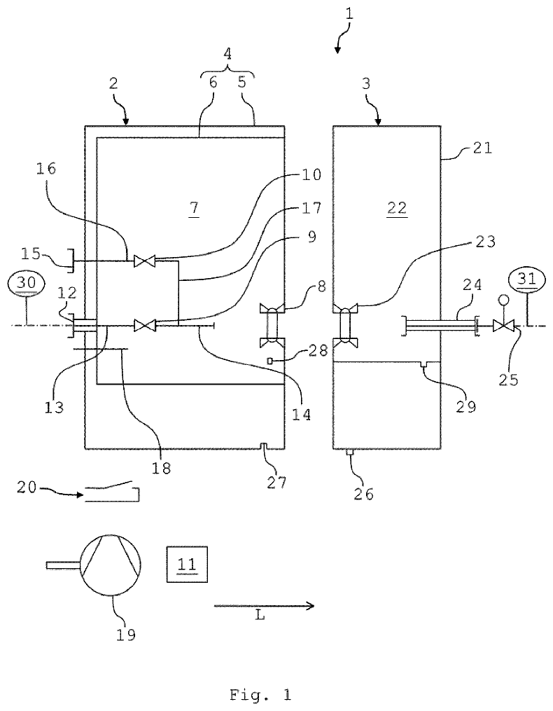

FIG. 1 shows a schematic view of an embodiment of a cryogenic refueling arrangement;

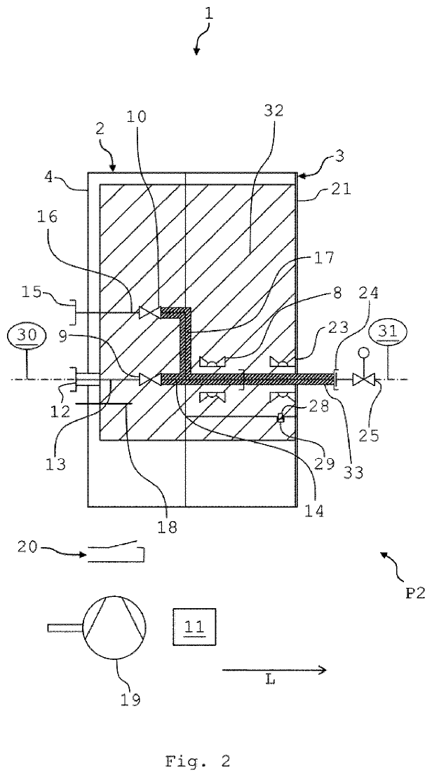

FIG. 2 shows a further schematic view of the cryogenic refueling arrangement;

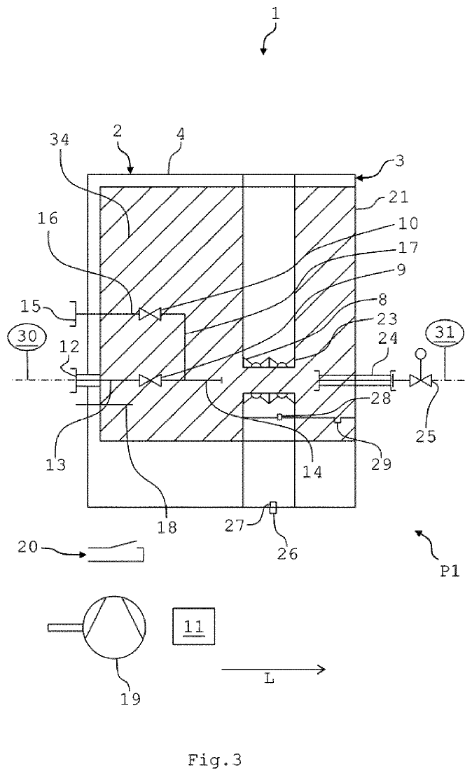

FIG. 3 shows a further schematic view of the cryogenic refueling arrangement; and

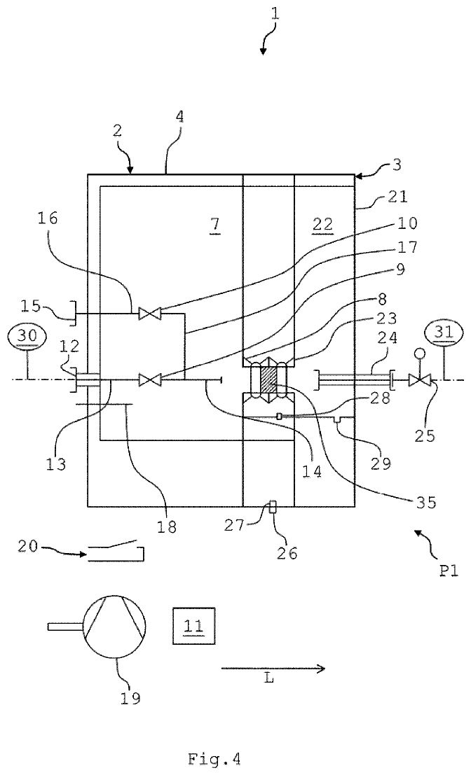

FIG. 4 shows a further schematic view of the cryogenic refueling arrangement.

In the figures, the same or functionally equivalent elements have been provided with the same reference signs unless otherwise indicated.

FIG. 1 shows a schematic view of a cryogenic refueling arrangement assembly 1. The cryogenic refueling arrangement 1 comprises a coupling device 2 and a receiver connector 3 for receiving the coupling device 2. The receiver connector 3 can accommodate the coupling device 2 at least in portions. For this purpose, the receiver connector 3 can have a receiving portion or receiving region. The coupling device 2 and the receiver connector 3 can be connected to one another and separated from one another again. In particular, the coupling device 2 and the receiver connector 3 can be plugged into one another in the form of a plug-socket principle. The coupling device 2 and the receiver connector 3 are designed to be complementary to one another for this purpose. The cryogenic refueling arrangement 1 is suitable for the purpose of refueling a storage tank with a cryogen, for example. The cryogen can be, for example, liquid hydrogen, monosilane, ethylene or the like.

The coupling device 2 comprises a housing 4 with an outer or first wall 5 and an inner or second wall 6 accommodated within the first wall 5. The housing 4 encloses a first volume 7. In particular, the second wall 6 surrounds the first volume 7. The coupling device 2 has a shut-off valve 8. The shut-off valve 8 enables fluidic access to the first volume 7. The shut-off valve 8 can be a valve, in particular an open/close valve. The shut-off valve 8 can be designed as an openable and closable flap, slider or the like. The shut-off valve 8 can be a ball valve or can be referred to as a ball valve.

The coupling device 2 has a main valve 9 and a venting valve 10. The main valve 9 and the venting valve 10 are preferably open/close valves. The main valve 9, the venting valve 10 and the shut-off valve 8 can be actuated by means of a control device 11. The main valve 9 and the venting valve 10 can preferably be actuated automatically. The main valve 9 and the venting valve 10 can be actuated independently of one another. The main valve 9 and the venting valve 10 are placed within the housing 4, in particular inside the second wall 6, i.e., within the first volume 7.

The main valve 9 and the venting valve 10 are connected parallel to one another. This means that the main valve 9 and the venting valve 10 are placed next to one another or adjacent to one another. This can be achieved structurally, for example, by the venting valve 10 being integrated into the main valve 9. For example, a valve piston or valve body of the venting valve 10 can be movably mounted in a valve bore provided within a valve piston or valve body of the main valve 9.

A line 13 leads from a coupling 12 to the main valve 9. The coupling 12 can be arranged at least in portions outside the housing 4. The coupling 12 is in particular vacuum insulated. A male coupling 14 leads away from the main valve 9. The coupling 14 is placed within the housing 4, in particular inside the second wall 6, i.e., within the first volume 7. The coupling 14 is accessible via the open shut-off valve 8 from an area surrounding the cryogenic refueling arrangement 1. A line 16 leads from a coupling 15 to the venting valve 10. A further line 17 leads away from the venting valve 10 and opens into the coupling 14. The line 13 and the line 16 are two separate lines. The main valve 9 is suitable for blocking or releasing the line 13. The venting valve 10 is suitable for blocking or releasing the line 16.

Since the coupling 14 is placed within the first volume 7, it is only accessible via the shut-off valve 8. The coupling 14 is thus shielded from the environment of the cryogenic refueling arrangement 1. A freezing of water vapor or gases at the coupling 14 is thereby prevented. The coupling 14 thus cannot ice up and always remains dry.

The first volume 7 is accessible via a line 18. The first volume 7 can, for example, be relieved or evacuated via the line 18. For this purpose, a vacuum pump 19 can be assigned to the coupling device 2. Furthermore, a start/stop button 20 can also be assigned to the coupling device 2. A refueling operation can be started and stopped using the start/stop button 20.

Returning to the receiver connector 3, it comprises a housing 21 that encloses a third volume 22. Furthermore, a second volume is also provided which will be discussed below. A shut-off valve 23 is assigned to the receiver connector 3. The shut-off valves 8, 23 can be arranged opposite one another. The shut-off valve 23 can also be a ball valve or be referred to as such. The receiver connector 3 further comprises a vacuum-insulated coupling 24 and a user valve 25. The user valve 25 can be opened and closed by a user.

The receiver connector 3 comprises a first engagement element 26, which can engage in a first counter-engagement element 27 of the coupling device 2 in an interlocking manner. That means that the coupling device 2 can be locked on the receiver connector 3. For example, the first engagement element 26 can be movably mounted so that it can be brought into engagement and disengaged from the first counter-engagement element 27. The first engagement element 26 can be actuated pneumatically or hydraulically, for example. As soon as the first engagement element 26 and the first counter-engagement element 27 interlock, the coupling device 2 and the receiver connector 3 are in a first position.

The coupling device 2 further comprises a second engagement element 28, which is suitable for engaging in a corresponding second counter-engagement element 29 of the receiver connector 3. For example, the second engagement element 28 can be movably mounted so that it can be brought into engagement and disengaged from the second counter-engagement element 29. The second engagement element 28 can be actuated pneumatically or hydraulically, for example. As soon as the second engagement element 28 and the second counter-engagement element 29 interlock, the coupling device 2 and the receiver connector 3 are located in a second position differing from the first position. In the second position, the coupling device 2 is pushed further into the receiver connector 3 as viewed along a longitudinal direction L of the cryogenic refueling arrangement 1 than it is in the first position. A first temperature measuring point 30 is connected upstream of the coupling 12. A second temperature measuring point 31 is connected downstream of the coupling 24.

The functionality of the cryogenic refueling arrangement 1 is explained below. First, the cryogenic refueling arrangement 1 is in an initial state shown in FIG. 2. In the initial state, the coupling device 2 is locked in a parking station at the previously mentioned second position P2. This means that the second engagement element 28 and the second counter-engagement element 29 engage one another. The main valve 9 is closed. The venting valve 10 is open. The user valve 25 is closed. Pressure and temperature in a fifth volume 32 (hatched) and in a sixth volume 33 (hatched) are undefined. Furthermore, a fourth volume is provided, which will be explained later. The sixth volume 33 is provided in the coupling 14, the line 17 and in the coupling 24. The couplings 14, 24 engage in one another. For this purpose, for example, the coupling 14 can be guided through the open shut-off valves 8, 23 to the coupling 24. Via the venting valve 10, the sixth volume 33 can be evacuated or compressed with a suitable gas, for example, hydrogen.

This is followed by a cooling process. The start of the cooling process is automated. An alternating pressure flushing of the fifth volume 32 takes place. The alternating pressure flushing can be carried out, for example, with gaseous hydrogen. Thereafter, the fifth volume 32 is evacuated via the line 18 and a vacuum hold test is carried out. If the vacuum hold test is positive, the process is continued. If the vacuum hold test is negative, the process is stopped and an error routine is performed. The venting valve 10 is opened. An alternating pressure flushing of the sixth volume 33 and a pressure hold test are performed. This alternating pressure flushing can also be carried out with gaseous hydrogen. If the pressure hold test is positive, the process is continued. If the pressure hold test is negative, the process is stopped and an error routine is performed.

A start of the transfer of the cryogen can begin as soon as the temperature at the second temperature measuring point 31 corresponds to the temperature at the first temperature measuring point 30 plus 10 K. The main valve 9 is opened. The venting valve 10 is closed. The user valve 25 is opened. The fifth volume 32 is evacuated. The sixth volume 33 is depressurized and cold. The temperature in the sixth volume 33 corresponds to the temperature at the second temperature measuring point 31. The cooling process is completed as soon as the target temperature is reached at the second temperature measuring point 31.

FIG. 3 shows the cryogenic refueling arrangement 1 after the cooling process, after the end of a refueling operation or after an emergency disconnection by the user. First, the transfer of the cryogen is stopped. A sub-process follows for release to unlock the coupling device 2 and the receiver connector 3. When the release takes place, the process is continued. If the release does not occur, the process is stopped and an error routine is performed. An alternating pressure flushing of the sixth volume 33 is performed via the coupling 15. The venting valve 10 is then closed.

The vacuum in the fifth volume 32 is relieved via the line 18. The second position P2 is unlocked so that the second engagement element 28 is disengaged from the second counter-engagement element 29. The fifth volume 32 is compressed via the line 18 with gaseous cryogen, so that the coupling device 2 and the receiver connector 3 move away from one another. The shut-off valves 8, 23 are still open, so that the volumes 7, 22 are in fluid connection with one another and form a common fourth volume 34.

The pressure in the fourth volume 34 is slowly increased until the coupling device 2 is in the first position P1 and can be locked therein by means of the first engagement element 26 and the first mating engagement element 27. After the locking in the first position P1, the fourth volume 34 is relieved via the line 18 to, for example, 1.2 bara. The main valve 9 is closed. The unlocking and the pneumatic pushing-out is completed when a switch or sensor assigned to the first engagement element 26 and the first counter-engagement element 27 outputs the information that the first engagement element 26 and the first counter-engagement element 27 are locked to one another.

As shown in FIG. 4, the shut-off valves 8, 23 are then closed. The closing can be triggered by an automatic control or by the start/stop button 20. A second volume 35 is provided between the closed shut-off valves 8, 23. The coupling device 2 and the receiver connector 3 are still locked in the first position P1. After the unlocking of the first engagement element 26 and the first counter-engagement element 27, the coupling device 2 can be decoupled from the receiver connector.

For coupling the coupling device 2 to the receiver connector 3, the coupling process is started by means of the start/stop button 20. Subsequently, a check is made as to whether the coupling device 2 is accommodated within the receiver connector in such a way that the first engagement element 26 can engage in the first counter-engagement element 27. If this is the case, the coupling device 2 and the receiver connector 3 are locked together in the first position P1. The third volume 22 and the second volume 35 are evacuated. The vacuum in the third volume 22 is checked. The shut-off valves 8, 23 are then opened.

The first position P1 is unlocked so that the first engagement element 26 and the first counter-engagement element 27 no longer engage in one another. The vacuum pulls the coupling device 2 into the second position P2. A check is made as to whether the coupling device 2 is placed relative to the receiver connector 3 in such a way that the second engagement element 28 and the second counter-engagement element 29 can engage one another. If this is the case, the coupling device 2 is locked in the second position P2. A pressure hold test and a dead space flushing are carried out. A stoppage or a termination of the coupling operation can be indicated via a display or the like.

After the coupling, a refueling operation can be carried out. The refueling operation can be triggered automatically or by means of the start/stop button 20. The triggering can be displayed via the aforementioned display. The transfer of the cryogen can only be started and also stopped again. The stoppage can be displayed, for example, by means of the display or the like.

Although the present invention has been described with reference to exemplary embodiments, it can be modified in many ways within the scope of the claims.

### REFERENCE SIGNS USED

1 Cryogenic refueling arrangement
2 Coupling device
3 Receiver connector
4 Housing
5 Wall
6 Wall
7 Volume
8 Shut-off valve
9 Main valve
10 Venting valve
11 Control device
12 Coupling
13 Line
14 Coupling
15 Coupling
16 Line
17 Line
18 Line
19 Vacuum pump
20 Start/stop button
21 Housing
22 Volume
23 Shut-off valve
24 Coupling
25 User valve
26 Engagement element
27 Counter-engagement element
28 Engagement element
29 Counter-engagement element
30 Temperature measuring point
31 Temperature measuring point
32 Volume
33 Volume
34 Volume
35 Volume
L Longitudinal direction
P1 Position
P2 Position

1. A coupling device for a cryogenic refueling arrangement, having a main valve, a venting valve for venting a volume provided downstream of the main valve and the venting valve in order to prepare the coupling device for a refueling operation, a housing which encloses a further volume in which the main valve and the venting valve are arranged, and a shut-off valve which is provided on the housing and by means of which the volume enclosed by the housing is accessible.

2. The coupling device according to claim 1, wherein the venting valve is pneumatically actuated.

3. The coupling device according to claim 1, further comprising a coupling leading away from the main valve, wherein the coupling is arranged within the volume enclosed by the housing, and wherein the coupling is accessible by means of the shut-off valve.

4. The coupling device according to claim 3, further comprising a line which leads from the venting valve toward the coupling and is in fluid communication with the coupling, wherein the volume provided downstream of the main valve and the venting valve is enclosed by the coupling and the line.

5. The coupling device according to claim 1, wherein the housing has a first wall and a second wall accommodated within the first wall, and wherein the main valve and the venting valve are arranged inside the second wall.

6. The coupling device according to claim 5, wherein the second wall surrounds the volume enclosed by the housing.

7. The coupling device according to claim 1, wherein the main valve and the venting valve are arranged parallel to one another.

8. A cryogenic refueling arrangement having a coupling device according to claim 1 and a receiver connector to which the coupling device can be coupled.

9. The cryogenic refueling arrangement according to claim 8, wherein the receiver connector comprises a first engagement element, wherein the coupling device comprises a first counter-engagement element corresponding to the first engagement element, and wherein the first engagement element, in a first position of the coupling device, engages in the first counter-engagement element in an interlocking manner.

10. The cryogenic refueling arrangement according to claim 9, wherein the coupling device comprises a second engagement element, wherein the receiver connector comprises a second counter-engagement element corresponding to the second engagement element, and wherein the second engagement element, in a second position of the coupling device differing from the first position, engages in the second counter-engagement element in an interlocking manner.

11. The cryogenic refueling arrangement according to claim 10, wherein the coupling device and the receiver connector are pushed further into one another in the second position than they are in the first position.

12. The cryogenic refueling arrangement according to claim 10, wherein a refueling operation can only be started in the second position.
